(19) United States
(12) Patent Application Publication
(10) Pub. No.: US 2010/0142055 A1
(43) Pub. Date: Jun. 10, 2010

(54) OPTICAL ELEMENT, DIRECTIONAL DIFFUSION FILM, AND METHOD OF MANUFACTURING OPTICAL ELEMENT

(75) Inventors: Kazuki Murayama, Ibaraki-shi (JP); Takeshi Murashige, Ibaraki-shi (JP); Tatsuki Nagatsuka, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/579,848

(22) Filed: Oct. 15, 2009

(30) Foreign Application Priority Data
Oct. 15, 2008 (JP) 2008-266648

(51) Int. Cl. G02B 5/02; G02B 5/00; B05D 3/06

(52) U.S. Cl. 359/599; 359/893; 427/487

(57) ABSTRACT

The present invention provides an optical element having a new structure that can he applied to a directional diffusion film suitably with a simpler process than before. An optical element includes a plurality of through holes in a transparent film matrix. The plurality of through holes are placed in a state where axial directions thereof are approximately in parallel with one another, and the axial directions of the through holes are inclined or approximately parallel to a thickness direction of the transparent film matrix.

### CROSS-REFERENCE TO RELATED APPLICATION

This application claims priority from Japanese Patent Application No. 2008-266648 filed on Oct. 15, 2008. The entire subject matter of the Japanese Patent Application is incorporated herein by reference,

### TECHNICAL FIELD

The present invention relates to an optical element, a directional diffusion film, and a method of manufacturing an optical element.

### BACKGROUND ART

Recently liquid crystal displays (LCDs) have been used widely in, for example, PCs, automated teller machines (ATMs), and car navigation system equipment. LCDs usually have configurations in which backlights are placed opposed to the viewing sides of liquid crystal cells. Light from light sources used for the backlights is diffusion light and is visible not only from the front directions of LCDs but also from the inclined directions thereof. However when LCDs are viewed from directions vertically or horizontally inclined from the front direction, luminance and contrast of images are considerably decreased. Therefore, viewing angles satisfying sufficient image quality are limited. Accordingly for privacy protection or various applications, LCDs that are visible from specific directions or have wide viewing angles are required. For the expansion of viewing angles, attachment of optical filters or the like to LCDs has been considered, and an optical filter formed in a state where two layers having different refractive indices are alternately overlapped has been proposed (for example, Patent Document 1). Further, a filter for a liquid crystal display element made of a light scattering plate has been proposed (for example, Patent Document 2). The light scattering plate is obtained by forming a film-like composition containing two or more photopolymerizable monomers or oligomers having different refractive indices, and then by irradiating the film-like composition with ultraviolet radiation,

However, in the manufacturing of these filters, ultraviolet wavelengths, transfer rates at ultraviolet irradiation, and the like had to be controlled strictly. Further, control of viewing angles using these filters was insufficient.

### RELATED ART

Patent Document 1: JP9(1997)-127331 A

Patent Document 2: JP7(1995)-209637 A

### DISCLOSURE OF INVENTION

### Problem to he Solved by the Invention

Hence, an Object of the present: invention is to provide an optical element, having a new structure that can be applied to a directional diffusion film suitably by a simpler process than before.

### Means for Solving Problem

In order to achieve the aforementioned object, the optical element of the present invention includes a plurality of through holes in a transparent film matrix. The plurality of through holes are placed in a state where axial directions thereof are approximately in parallel with one another, and the axial directions of the through holes are inclined or approximately parallel to a thickness direction of the transparent film matrix.

The directional diffusion film of the present invention, is a directional diffusion film including an optical element, wherein the optical element is the optical element of the present invention.

The method of manufacturing an optical element of the present invention is a method of manufacturing an optical element including a plurality of through holes in a transparent film matrix. The plurality of through holes are placed in a state where axial directions thereof are approximately in parallel with one another, the axial directions of the through holes are inclined or approximately parallel to a thickness direction of the transparent film matrix, and the through holes are filled with a low-molecular substance. The method includes processes of providing an optical element-forming material containing a monomer having a photopolymerizable functional group and a low-molecular substance, the difference between SP values thereof being in a range from 1.5 to 3; forming an optical element-forming material layer by coating a first substrate with the optical element-forming material; and irradiating the optical element-forming material layer with a parallel beam.

The optical element of the present invention is manufactured by the method of manufacturing an optical element of the present invention.

### Advantageous Effects or the Invention

The optical element of the present invention has a new structure and shows favorable directional scattering. Further, the optical element of the present invention can be manufactured by a very simple process as compared to conventional optical elements. Use of the optical element of the present invention makes it possible to obtain a directional diffusion film visible in a specific direction that can be suitably used for displays such as liquid crystal displays and the like.

### BRIEF DESCRIPTION OF DRAWINGS

FIG. 1 is a view for explaining an example of the method of manufacturing an optical element of the present invention.

FIG. 2 is a graph showing measurement results of scattering properties of optical elements in Examples 1 and 5, and Comparative Example 7.

FIG. 3 is photographs (surface (a), cross section (b)) of an appearance of an optical element observed in Example 1.

FIG. 4 is a view for explaining another example of the method of manufacturing an optical element of the present invention.

FIG. 5(a) is a photograph of a cross section of an optical element observed in Example 6.

FIG. 5(b) is a graph showing a measurement result of a scattering property of an optical element in Example 6.

FIG. 6 is a graph showing measurement results of scattering properties of optical elements in Example 1 and Comparative Example 8.

FIG. 7 is a photograph of a surface of an optical element observed in Comparative Example 8.

### DESCRIPTION OF THE INVENTION

Preferably, in the optical element of the present invention, the transparent film matrix is made of polymer.

In the optical element of the present invention, the diameter of the through hole is preferably in the range from 0.5 to 10 μm and more preferably in the range from 1 to 8 μm.

In the optical element of the present invention, the thickness is preferably in the range from 10 to 470 μm, more preferably in the range from 10 to 150 μm, and further preferably in the range from 10 to 100 μm.

Preferably in the method of manufacturing an optical element of the present invention, on the optical element-forming material layer on the first substrate in the process of forming the optical element-forming material layer, a second substrate is further placed the optical element-forming material layer is interposed between the both substrates, and the optical element-forming material layer is irradiated with the parallel beam in this state.

Preferably, in the method of manufacturing an optical element of the present invention, the parallel beam is ultraviolet radiation.

Preferably, in the method of manufacturing an optical element of the present invention, the monomer has at least two polymerizable functional groups.

Preferably in the method of manufacturing an optical element of the present invention, the polymerizable functional groups are acrylate groups.

Preferably in the method of manufacturing an optical element of the present invention, the low-molecular substance is a solvent.

Preferably, in the method of manufacturing an optical element of the present invention, the monomer and the low-molecular substance are used in combination, wherein the difference between the SP values thereof are in the range from 1.5 to 3. The difference between the SP values thereof is preferably in the range from 1.6 to 2.9 and more preferably in the range from 1.7 to 2.8.

Preferably, in the method of manufacturing an optical element of the present invention, the monomer has an SP value in the range from 11.7 to 13.4.

Preferably, in the method of manufacturing an optical element of the present invention, the low-molecular substance has an SP value in the range from 9.7 to 10.4.

Preferably in the method of manufacturing an optical element of the present invention, the monomer is at least a liquid crystalline monomer.

Preferably, the method of manufacturing an optical element of the present invention includes a process of removing the low-molecular substance after the process of parallel beam irradiation.

Preferably, in the method of manufacturing an optical element of the present invention, after the process of removing the low-molecular substance, portions which are obtained by removing low-molecular substance are filled with a substance having a refractive index different from that of a polymer made by polymerization in the process of parallel beam irradiation.

Next, the present invention is described in detail. However, the present invention is not limited by the following descriptions.

The optical element of the present invention includes plural through holes in a transparent film matrix.

The transparent film matrix is preferably made of polymer. More preferably the polymer is made by the polymerization of a monomer having a photopolymerizable functional group as a main component.

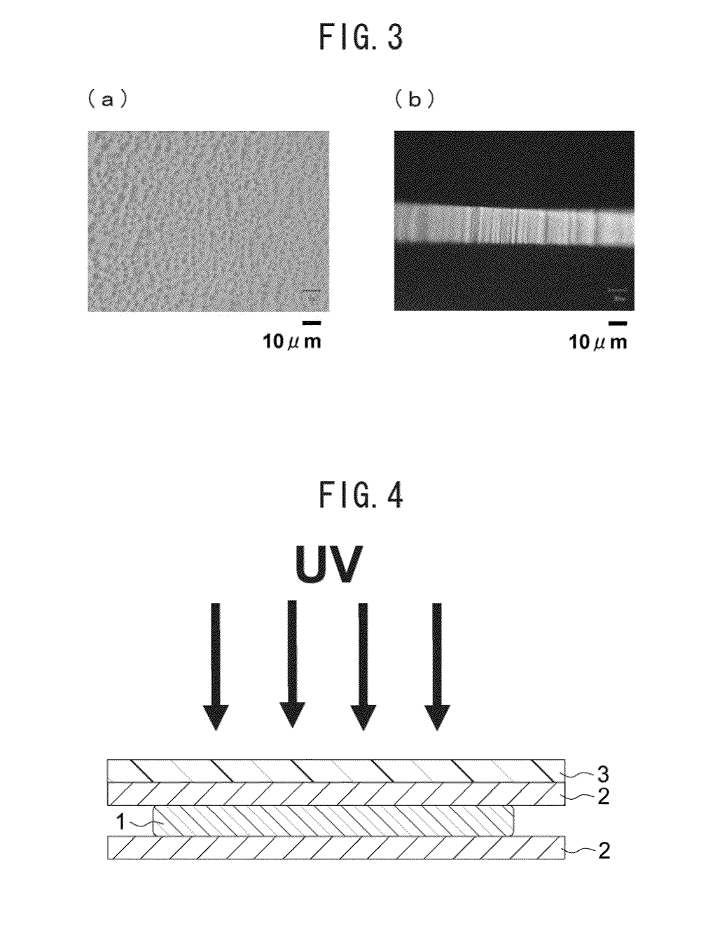

The through holes are formed, for example, as shown in the photograph in FIG. 3. The through holes are cavities, i.e. air exists in the through holes. Therefore, each of the through holes has a refractive index different from that of the transparent film matrix.

In the present invention, the plural through holes are placed in the transparent film matrix in a state where axial directions thereof are approximately in parallel with one another. The axial directions of the through holes may be inclined or approximately parallel to the thickness direction of the transparent film matrix. For example, in an embodiment where the through holes are filled with a substance having a refractive index different from that of the transparent film matrix described later, the optical element of the present invention, in which the through holes are placed inclined or approximately parallel to the thickness direction thereof, has a characteristic that a light beam having an incidence angle that is parallel to the axial directions of the through holes is diffused. Alternatively, in the case where the substance in the through holes is a light absorbing substance, the optical element of the present invention has a characteristic that a light beam that is not approximately parallel to the axial direction of the through hole is absorbed h the light absorbing substance and only a light beam that is approximately parallel to the axial direction of the through hole is transmitted.

In the present invention, the expression “approximately parallel” includes a case of practically parallel. In the case of practically parallel, an inclination angle is, for example, in the range from 0±2 degrees and preferably in the range from 0±1 degree.

The diameter of the through hole is preferably in the range from 0.5 to 10 μm and more preferably in the range from 1 to 8 μm. When the diameter is too thin, for example, less than 0.5 μm, the characteristic of the optical element is not sufficiently expressed although there is the difference between the refractive index of the transparent film matrix and the refractive index of the through hole. In contrast, when the diameter exceeds 10 μm, brilliance cannot be obtained and a favorable optical characteristic cannot be obtained. The average value of the diameter of the through hole is preferably in the range from 2 to 6 μm.

The thickness of the optical element is preferably in the range from 10 to 470 μm. When the thickness is 10 μm or more, the effect as the optical element becomes sufficiently apparent. When the thickness is 470 μm or less, the photo polymerization of the optical element is favorably progressed.

The optical element of the present invention described above can be used for a directional diffusion film. In the case where the optical element is used for a directional diffusion film, light from the axial direction of the through hole can be diffused and light from other directions can be transmitted.

For example, the optical element of the present invention can be manufactured by processes of providing an optical element-forming material containing a monomer having a photopolymerizable functional group and a low-molecular substance, forming an optical element-forming material layer by coating a first substrate with the optical element-forming material, and irradiating the optical element-forming material layer with a light beam. The light beam is preferably a parallel beam. The light beam may be polarized light or unpolarized light. Light beam irradiation is not particularly limited, and various activation energies can be used for the method of irradiation. The polymerization of the monomer having a photopolymerizable functional group is progressed due to the light beam irradiation. The light beam is preferably ionizing radiation and particularly preferably ultraviolet radiation. Preferable examples of energy beam sources include beam sources of a high-pressure mercury lamp, a halogen lamp, a xenon lamp, a metal halide lamp, a nitrogen laser, an electron beam accelerator, and a radiation element. The irradiation amount of the energy beam source is preferably from 15 to 700 mJ/cm² as an integrated exposure amount at an ultraviolet wavelength of 365 nm. When the irradiation amount is 15 mJ/cm² or more, sufficient hardening can he performed and a sufficient hardness of a transparent film matrix to he formed can he obtained. When the irradiation amount is 700 mJ/cm² or less, coloring of a transparent film matrix to be formed can be prevented and a transparency can be improved. The irradiation intensity of the energy beam source is preferably in the range from 1 to 100 mW/cm².

According to the aforementioned method, the axes of the through holes are formed approximately parallel to the direction of the light beam irradiation, and the axial directions of the through holes can be controlled by controlling the light beam irradiation direction with respect to the optical element-forming material layer. For example, the through holes are formed approximately parallel to the thickness direction of the optical element-forming material layer when the optical element-forming material layer is irradiated with a light beam from the normal direction thereof. The through holes are formed inclined with respect to the thickness direction of the optical element-forming material layer when the optical element-forming material layer is irradiated with a light beam from an inclined direction with respect to the thickness direction thereof. Further, according to the aforementioned method, in the process of light beam irradiation, the through holes can be formed in a transparent film matrix without involving a mask or the like.

It is estimated that the optical element of the present invention is formed, for example, by the following mechanism in the aforementioned method. However, the present invention is not limited by the estimation at all. When an optical element-forming material containing a monomer having a photopolymerizable functional group and a low-molecular substance is irradiated with a light beam, polymerization is started at the side irradiated with the light beam, and the molecular weight begins to increase. In this state, the refractive indices of polymer-forming areas become greater than the refractive indices of areas around the polymer-forming areas, and the light beam is focused by the lens effect due to the refractive index difference. The light beam this focused moves in an optical element-forming material in the direction approximately parallel to the light irradiation direction. Along the moving direction of the focused light beam, polymerization is further progressed in the optical element-forming material. On the other hand, some of the light are not focused and are leaked from the interfaces between polymer-forming areas and polymer-nonforming at to the polymer-nonforming areas, and polymerization for expanding the polymer-forming area in a width direction occurs. Due to the polymerization for expanding in the width direction, plural polymer-forming areas are connected, and thereby a transparent film matrix is formed. As a result, through holes in which the low-molecular substance is mainly remained and surrounded by a transparent film matrix are formed along the light beam irradiation direction.

In the process of light beam irradiation, light beam irradiation can be performed by a continuous process by moving an optical element-forming material layer on a conveyer, or can be performed by a batch process in which a certain area of an optical element-forming material layer is wholly irradiated with a light beam.

Preferably, in the process of forming an optical element-forming material layer, a second substrate is further placed on the optical element-forming material layer on the first substrate, the optical element-forming material layer is interposed between the both substrates, and the process of light beam irradiation is performed in this state. In this case, both substrates may he light transmissive substrates or only one of them may be a light transmissive substrate. In the case where only one of the substrates is a light transmissive substrate, in the process of light beam irradiation that is the next process, light beam irradiation is performed at the side of the light transmissive substrate. When the optical element-forming material layer is interposed between the substrates, the component change of the optical element-forming material in the processes of manufacturing an optical element hardly occurs even when the low-molecular substance is a material that is easily vaporized. Therefore, an optical element of stable quality can be obtained, and it is preferable. Further, when the monomer is a material having a higher volume shrinkage factor by polymerization, there is an advantage that the surface of the optical element obtained can be smoother.

The substrates are not particularly limited, however in the case where an optical element is manufactured by irradiating an optical element-forming material layer interposed between two substrates with a light beam, it is required that at least one of the substrates is a light transmissive substrate. As the light transmissive substrate, a glass substrate and a transparent plastic film substrate can be used suitably Examples of the transparent plastic film substrate include polyester polymers such as polyethylene terephthalate and polyethylene naphthalate; cellulose polymers such as diacetyl cellulose and triacetyl cellulose; polycarbonate polymers; and acrylic polymers such as polymethylmethacrylate. Further, examples of the transparent plastic film substrate include styrene polymers such as polystyrene and an acrylonitrile-styrene copolymer olefin polymers such as polyethylene, polypropylene, polyolefin having a cyclic or a norbornene structure, and an ethylene-propylene copolymer; vinyl chloride polymers; and amide polymers such as nylon and aromatic polyamide. Moreover, examples of the transparent plastic film substrate include imide polymers, sulfone polymers, polyether sulfone polymers, polyether ether ketone polymers, polyphenylene sulfid polymers, vinyl alcohol polymers, vinylidene chloride polymers, vinyl butyral polymers, arylate polymers, polyoxymethylene polymers, epoxy polymers, and blended products of the aforementioned polymers.

In the present invention, the thickness of the transparent plastic film substrate is not particularly limited. However, in consideration of strength, operability such as handling ability and thinning ability the thickness is preferably in the range from 10 to 500 μm, more preferably in the range from 20 to 300 μm, and most preferably in the range from 30 to 200 μm. The refractive index of the transparent plastic film substrate is not particularly limited, and is, for example, in the range from 1.30 to 1.80 and preferably in the range from 1.40 to 1.70.

The optical element of the present invention with the substrates can be used directly as a directional diffusion film. The directional diffusion film can be used for a polarizing plate as a protective film. In such a case, the substrate is preferably a film made of triacetylcellulose (TAC), polycarbonate. acrylic polymers, polyolefin having a cyclic or a norbornene structure, or the like. Alternatively, in the present invention, the film substrate may be a polarizer itself. With such a structure, a protective layer made of TAC or the like is not required and the structure of a polarizing plate can be simplified. Therefore, the number of manufacturing processes of a polarizing plate or an image display can be reduced and productivity can be improved. Further, such a structure allows a polarizing plate to be further thinned. In the case where the substrate is a polarizer, the optical element of the present invention serves as a conventional protective layer. Further, with such a structure, the directional diffusion film of the present invention also serves as a cover plate that is attached to the surface of a liquid crystal cell.

Although the light beam is a parallel beam as described above, an optical element having diffusivity can be obtained also using diffusion light as long as it has a half-width of a predetermined range. The half-width of the diffusion light can be controlled suitably in the range from 0 to 30° as required. In the diffusion light irradiation, an optical element can be obtained also by laminating a diffusion plate, on the optical element-forming material layer as a second substrate, and irradiating the optical element-forming material layer with a parallel beam from the side of the diffusion plate. Alternatively an optical element can be obtained by laminating a diffusion plate on a second substrate formed on the optical element-forming material layer, and irradiating the optical element-forming material layer with a parallel beam from the side of the diffusion plate. In this state, the half-width is a diffusion angle of collimated light that is entered into a diffusion plate and shows an outgoing light intensity of 50% with a peak intensity of outgoing light being 100%.

The transparent film matrix is made by the polymerization of the monomer having a photopolymerizable group that is a component of the optical element-forming material. Examples of monomers having photopolymerizable functional groups include ultraviolet curable monomers and ionizing radiation curable monomers. Among them, ultraviolet curable monomers that can efficiently farm a transparent film matrix by a simple processing operation such as a cure treatment by ultraviolet irradiation are particularly preferably used. An ultraviolet polymerization initiator (photopolymerization initiator) may be added to the ultraviolet curable monomer.

Examples of the ultraviolet curable monomers include various types of monomers such as polyester monomers, acrylic monomers, urethane monomers, silicone monomers, and epoxy monomers. Particularly preferable examples of the ultraviolet curable monomers include monomers having ultraviolet polymerizable functional groups, and above all, monomers each having at least two functional groups are preferable. Particularly, monomers each having two functional groups are preferable. In the case of using monomers each having one functional group, filming by photopolymerization hardly occurs.

Specific examples of such ultraviolet curable monomers include acrylate monomers such as acrylic acid esters of polyalcohols, methacrylate monomers such as methacrylic acid esters of polyalcohols, diisocyanate, multifunctional urethane acrylate monomers synthesized from hydroxyl alkyl esters of polyalcohols and acrylic acids, and multifunctional urethane methacrylate monomers synthesized from hydroxyl methacryl esters of polyalcohols and methacrylic acids. Further, melamine monomers, urethane monomers, alkyd monomers, silicone monomers are preferably used. Among them, those having acrylate groups as the polymerizable functional groups are particularly preferable.

The monomers may be used alone or two or more of them used in combination. For the monomers, it also is possible to use for example, commercial photocurable monomers. Furthermore, the use of photocurable liquid crystalline monomers also is preferable. In such a case, liquid crystalline monomers each having two acrylate groups are more preferable. By using liquid crystalline monomers, promotion of reaction among side chains derived from molecular orientation can be expected. Examples of the liquid crystalline monomers include “PALIOCOLOR® LC242” (trade name, BASF) and “L42” and “L55” (trade names, Takasago International Corporation).

An example of the monomer includes a compound represented by the following general formula (1).

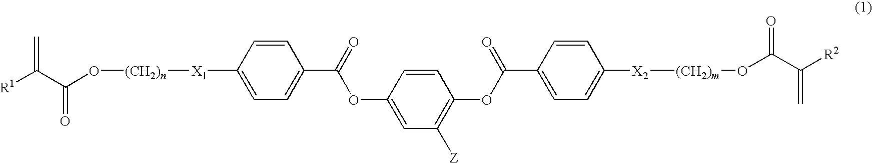

In the formula (1), R¹ and R² each independently represent hydrogen or a methyl group, and preferably R¹ and R² both represent hydrogen. The X₁ and X₂ are each independently selected from the group consisting of an ether group, a carbonyl group, an ester group, and a carbonate group. Z is selected from the group consisting of hydrogen, halogen, an alkyl group or an alkoxy group having 1 to 4 carbon atoms, a cyano group, and a nitro group, and is preferably chlorine or a methyl group.

Examples of the photopolymerization initiator include 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzil dimethyl ketal, N,N,N′,N′-tetramethyl-4,4′-diaminobenzophenone, and 1-(4-isopropylphenyl)-2-hydroxy-2-methylpropane-1-on. Besides them, thioxanthone compounds and the like can be used.

In the method of manufacturing an optical element of the present invention, the low-molecular substance is preferably a solvent. By irradiation of an optical element-forming material layer with a light beam, the low-molecular substance is mainly distributed in the through holes unevenly. When the low-molecular substance is a solvent, after forming the transparent film matrix and the through holes, the solvent unevenly distributed in the through holes can be easily vaporized to remove, for example, by an ordinary temperature or heating, pressure reducing, a blower, or the like. In the case of using a material relatively hard to vaporize such as a high-boiling-point solvent as the low-molecular substance, the material can be eluted using a low-boiling-point solvent after forming the through holes. In the case of removing the low-molecular substance, the through holes from which the low-molecular substance is removed may he left as they are (air exists therein) or are preferably filled with another substance having a refractive index different from that of the transparent film matrix. According to this method, even when materials having SP values outside a predetermined range described later are used, an optical element having the structure of the present invention can easily be manufactured. Therefore, optical elements having various characteristics can be designed.

As the materials to be charged, ultraviolet curable and heat curable epoxy resins, oxetane resins, acrylic resins, and mixtures thereof can be used. Further, as required, inorganic particles such as silica, titania, zirconia, and glass; dyes; and pigments can be added to the aforementioned resins and the mixtures thereof. Moreover, after through holes are impregnated with a mixture of a thermoplastic resin and a solvent, the through holes can be filled with a substance by removing the solvent.

As the low-molecular substance, a material having a crosslinking group that is polymerizable by a method other than photopolymerization can be used. In this case, the through holes in which the low-molecular substance is crosslinked can be formed by performing, for example, a process such as heat polymerization after the process of light beam irradiation. Further, in this case, it also is possible to control an optical characteristic by selectively coloring or dyeing the low-molecular substance.

In the method of manufacturing an optical element of the present invention, the monomer and the low-molecular substance are used in combination, wherein the difference between the SP values thereof are in the range from 1.5 to 3. The difference between the SP values thereof is preferably in the range from 1.6 to 2.9 and more preferably in the range from 1.7 to 2.8. The SP value is a solubility parameter (δ). In the present invention, the SP value is calculated with the following formula, based on the description of Small, “Some factors affecting the solubility of polymers”, J. Appl. Chem., Vol. 3 (1953), pp. 71-80.

$$\begin{matrix}δ = \frac{Σ F}{V} \\ = {( \frac{{E}_{v}}{V} )}^{1 / 2} \\ = {( \frac{{\sum }_{i} {n}_{i} {e}_{i}}{v} )}^{1 / 2}\end{matrix}$$

In the formula, F represents a molecular attraction constant (=(Eᵥ×V)^{1/2}), Eᵥ represents evaporation energy, V represents a molar volume, eᵢ represents evaporation energy of each constituent group, and nᵢ represents the number of constituent groups. When the difference between the SP values exceeds 3, the monomer is sometimes not compatible with the low-molecular substance. Further, when the difference between the SP values is less than 1.5, polymerization phase separation less likely occurs because the monomer is too much compatible with the low-molecular substance, and the through holes are less likely formed.

In the method of manufacturing an optical element of the present invention, the monomer preferably has an SP value in the range from 11.7 to 13.4. An example of the monomer having an SP value within the aforementioned range includes the liquid crystalline monomer LC242 (SP value: 12.3).

In the method of manufacturing an optical element of the present invention, the low-molecular substance preferably has an SP value in the range from 9.7 to 10.4. An example of the low-molecular substance having an SP value within the aforementioned range includes cyclopentanone (SP value: 10.4) and methylene chloride (SP value: 9.7).

The optical element-forming material may further contain any suitable additives. Examples of the additives include surfactants, plasticizers, heat stabilizers, light stabilizers, lubricants, antioxidants, ultraviolet absorbers, flame retardants, colorants, antistatic, cross-linkers, thickeners, and metals.

When the optical element-forming material layer is formed by coating a first substrate with the optical element-forming material without using a second substrate, i.e., when the optical element-forming material layer is formed being in contact with air the surfactant is added in the aim of forming the smooth surface. Examples of the surfactants include silicone, surfactants, acrylic surfactants, and fluoric surfactants.

Further, the optical element-forming material may contain other resins as long as compatibility between the monomer and the low-molecular substance are not markedly changed. Examples of the other resins include various general-purpose resins, engineering plastics, thermoplastic resins and heat curable resins.

Examples of the general-purpose resins include polyethylene (PE), polypropylene (PP), polystyrene (PS), polymethyl methacrylate (PMMA), ABS resins, and AS resins. Examples of the engineering plastics include polyacetate (POM), polycarbonate (PC), polyamide (PA: nylon), polyethylene terephthalate (PET), and polybutylene terephthalate (PBT). Examples of the thermoplastic resins include polyphenylenesulfide (PPS), polyether sulfone (PES), polyketone (PK), polyimide (PI), polycyclohexane dimethanol terephthalate (PCT), polyarylate (PAR), and a liquid crystalline polymer (LCP). Examples of the heat curable resins include epoxy resins and phenol novolac resins.

When the other resins are added to the optical element-forming material in this manner, the amount of the resin to be added with respect to the optical element-forming material is in the range from 0 to 50% by weight and preferably in the range from 0 to 30% by weight.

The optical element-forming material layer can be formed simply by interposing between two substrates. Examples of the method of forming the optical element-forming material layer include a spin coating method, a roll coating method, a flow coating method, a printing method, a dip coating method, a cast coating method, a bar coating method, and a gravure printing method.

The optical element of the present invention can be used preferably for a viewing angle controlling film for an LCD. When the optical element of the present invention is used for an LCD with axial directions of the through holes being selected, favorable visibility can be obtained in areas around the selected directions. Further, the optical element, of the present invention can be used preferably for a viewing angle expanding film for an LCD. For example, in an LCD, since tone reversal from an inclined directional view can be improved, by laminating the optical element of the present invention along a viewing angle in which tone is reversed, the viewing angle can be expanded.

The liquid crystal display produced using an optical element of the present invention may be used for any suitable applications. Examples of the applications include office automation equipment such as a PC monitor, a notebook PC, and a copy machine, portable devices such as a mobile phone, a watch, a digital camera, a personal digital assistant (PDA), and a handheld game machine, home electric, appliances such as a video camera, a television set, and a microwave oven, vehicle equipment such as a back monitor, a monitor for a car-navigation system, and a car audio device, display equipment such as an information monitor for stores, security equipment such as a surveillance monitor, and nursing and medical equipment such as a monitor for nursing care and a monitor for medical use.

### Examples

Next, Examples of the present invention are described together with Comparative Examples. The present invention is neither limited nor restricted by the following Examples or Comparative Examples. With respect to the configurations and details of the present invention, various changes understandable to those skilled in the art can be made within the scope of the present invention. Various properties and physical properties in the respective Examples and Comparative Examples were evaluated or measured by the following methods.

Thicknesses of Optical Element>

Using a digital micrometer (“K-351C” (trade name), Anritsu Corporation), the whole thickness of the optical element and the substrates between which the optical element was interposed was measured and the thickness of the substrates was subtracted from the whole thickness. Thus the thickness of the optical element was calculated.

<Scattering Properties>

Scattering properties were measured using an optical film property evaluation apparatus (“GONIOPHOTOMETER” (trade name), Sigma Koki, Co. LTD.).

<Observation of Surface and Cross Section>

The surface and the cross section of the optical element were observed using a semiconductor FPD inspection microscope for 300 mm (“MX61L” (trade name). Olympus Corporation). The surface of the optical element was observed with a 100× magnification and the cross section was observed with a 50× magnification.

<Diameter of Through Hole>

With respect to the diameter of the through hole of an optical element, the micrograph of the surface of the optical element was taken with a magnification of 100 times, 40 points per sample were calculated, and this operation was repeated for four times. With respect to the average value of the diameter, the average value of the observation results of 40 points was calculated, this operation was repeated for four times, and the average value of each calculation result was obtained.

### Example 1

0.4 g of “PALIOCOLOR® LC242 (trade name, BASF, SP value: 12.8) as a monomer, 0.38 g of cyclopentanone (CPN, SP value: 10.4) as a low-molecular substance, and 0.02 g of IRGACURE 184 (Ciba Specialty Chemicals) as a photopolymerization initiator were mixed to prepare an optical element-forming material. The LC242 is a liquid crystalline monomer represented by the following chemical formula (2) and having two acrylate groups.

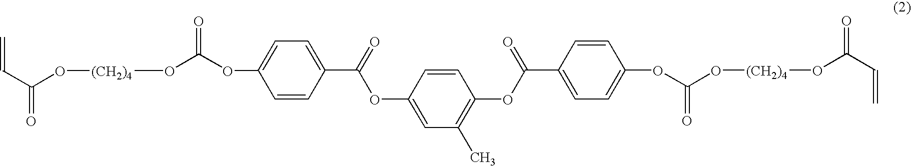

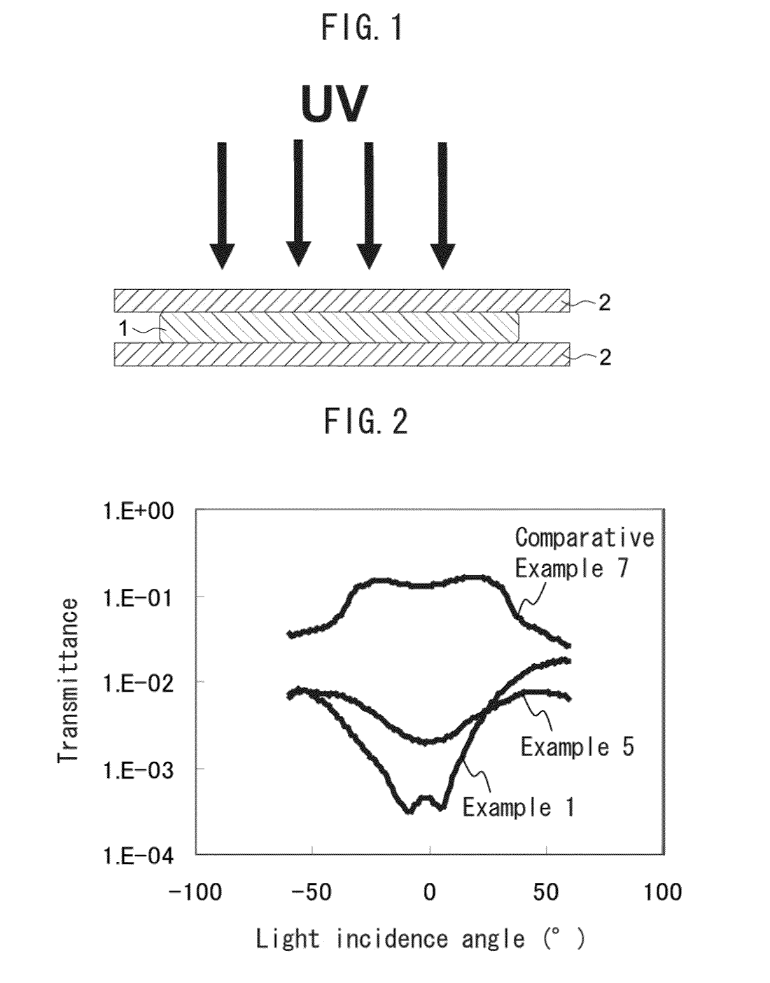

The optical element-forming material was dropped on a polyethylene terephthalate (PET) film (“FRV75” (trade name), Mitsubishi Chemical Corporation, thickness: 75 μm), which was serving as a substrate. Then a film identical to the PET film was placed thereon, an optical element-forming material 1 was interposed between two PET films 2 as shown in FIG. 1, and thereby an optical element-forming material layer was formed. The optical element-forming material layer was subjected to an ultraviolet irradiation apparatus (ultraviolet irradiation source “HC-300FM”, Yamashita Denso Corporation) and irradiated with polarized collimated light of a wavelength of 365 nm (140 (mJ/cm²)×min, 2 mW/cm²) from the approximately normal direction of the film.

Due to the irradiation, the optical element-forming material was cured and a film-like optical element was obtained between the two PET films. When the scattering property of the optical element with the PET films having was measured, the optical element had a property shown in FIG. 2 and showed directional scattering. When the surface and the cross section of the optical element obtained were observed, as shown in the photograph in FIG. 3(a), the surface of the optical element obtained had a number of oval structures having diameters in the range from 2 to 6 μm. As shown in the photograph in FIG. 3(b), in the thickness direction of the optical element obtained, through holes were formed along the light beam irradiation direction (a direction approximately parallel to the thickness direction) in a state where axial directions of the through holes were approximately parallel with one another.

### Example 2

The optical element of Example 2 was produced in the same manner as Example 1 except that 0.2 g of the LC242 (SP value: 12.3) as a monomer, 0.79 g of CPN (SP value: 10.4) as a low-molecular substance, and 0.01 g of IRGACURE 184 as a photopolymerization initiator were mixed to prepare an optical element-forming material.

### Example 3

The optical element of Example 3 was produced in the same manner as Example 1 except that 0.4 g of the LC242 (SP value: 12.3) as a monomer, 0.38 g of methylene chloride (SP value: 9.7) as a low-molecular substance, and 0.02 g of IRGACURE 184 as a photopolymerization initiator were mixed to prepare an optical element-forming material.

### Example 4

The optical element of Example 4 was produced in the same manner as Example 1, except that 0.2 g of the LC242 (SP value: 12.3) as a monomer, 0.79 g of methylene chloride (SP value: 9.7) as a low-molecular substance, and 0.01 g of IRGACURE 184 as a photopolymerization initiator were mixed to prepare an optical element-forming material.

### Example 5

The optical element of Example 5 was produced in the same manner as Example 1 except that, as shown in FIG. 4, a diffusion plate 3 (“LSD 20” (trade name), Luminit LLC, thickness: 135 μm) having a half-width of 20° was placed on a PET film 2 at the side irradiated with ultraviolet. When the scattering property of the optical element with the PET films was measured, the optical element had a property shown in FIG. 2 and showed directional scattering although it was weaker than Example 1.

### Example 6

0.4 g of the LC242 (SP value: 12.3) as a monomer, 0.38 g of CPN (SP value: 10.4) as a low-molecular substance, and 0.02 g of IRGACURE 184 as a photopolymerization initiator were mixed to prepare an optical element-forming material.

The optical element-forming material was interposed between two PET films in the same manner as Example 1, and thereby an optical element-forming material layer was obtained. The optical element-forming material layer was subjected to an ultraviolet irradiation apparatus (ultraviolet irradiation source “HC-300FM”, Yamashita Denso Corporation) and irradiated with polarized collimated light of a wavelength of 365 nm (140 (mJ/cm²)×min, 2 mW/cm²) from the approximately normal direction of the film.

Due to the irradiation, the optical element-forming material was cured. The two PET films were stripped the low-molecular substance was vaporized to remove, and thereby a film-like optical element was obtained. The optical element obtained showed directional scattering. When the surface of the optical element was observed, as same as the optical element shown in FIG. 3(a), there were a number of oval hollow holes. The diameters of the hollow holes were in the range from 2 to 6 μm and the average value was 4 μm. When the cross section was observed, as same as the optical element shown in FIG. 3(b), in the thickness direction of the optical element obtained, through holes were formed along the light beam irradiation direction (a direction approximately parallel to the thickness direction) in a state where axial directions of the through holes were approximately parallel to one another.

### Example 7

0.4 g of the LC242 (SP value: 12.3) as a monomer, 0.38 g of CPN (SP value: 10.4) as a low-molecular substance, and 0.02 g of IRGACURE 184 as a photopolymerization initiator were mixed to prepare an optical element-forming material. The optical element-forming material was interposed between two PET films in the same manner as Example 1, and thereby an optical element-forming material layer was obtained. The optical element-forming material layer was subjected to an ultraviolet irradiation apparatus (ultraviolet irradiation source “HC-300FM” Yamashita Denso Corporation) and irradiated with polarized collimated light of a wavelength of 365 nm (140 (mJ/cm²)×min, 2 mW/cm²) at an incidence angle of 30° from the normal direction of the film.

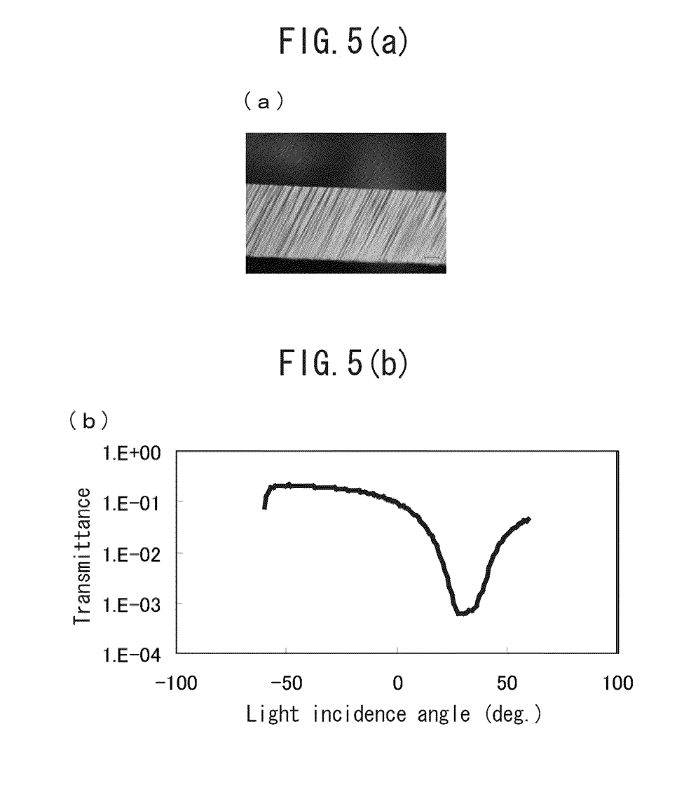

Due to the irradiation, the optical element-forming material was cured and a film-like optical element was obtained between the two PET films. When the cross section of the optical element obtained was observed, as shown in the photograph in FIG. 5(a), in the thickness direction of the optical element obtained, through holes were formed along the light beam irradiation direction (a direction approximately 30° with respect to the thickness direction) in a state where axial directions of the through holes were approximately parallel to one another. Further, when the scattering property of the optical element with the PET films was measured, the optical element, had a property shown in FIG. 5(b) and showed a scattering property of having directivity in the vicinity of an incidence angle of 30°.

### Comparative Example 1

The conditions of Comparative Example 1 were same as those of Example 1 except that benzyl methacrylate (SP value: 10.8), which is monoacrylate, was used as a monomer. However, even after ultraviolet irradiation, an optical element-forming material layer did not become a film.

### Comparative Example 2

The conditions of Comparative Example 2 were same as those of Example 2 except that benzyl methacrylate (SP value: 10.8), which is monoacrylate, was used as a in monomer. However, even after ultraviolet irradiation, an optical element-forming material layer did not become a film.

### Comparative Example 3

The conditions of Comparative Example 3 were same as those of Example 3 except that benzyl methacrylate (SP value: 10.8), which is monoacrylate, was used as a monomer. However, even after ultraviolet irradiation, an optical element-forming material layer did not become a film.

### Comparative. Example 4

The conditions of Comparative Example 4 were same as those of Example 4 except that benzyl methacrylate (SP value: 10.8), which is monoacrylate, was used as a monomer. However, even after ultraviolet irradiation, an optical element-forming material layer did not become a film.

### Comparative Example 5

The conditions of Comparative Example 5 were same as those of Example 3 except that benzyl methacrylate (SP value: 10.8), which is monoacrylate, was used as a monomer, and xylene (SP value: 8.8) was used as a low-molecular substance. However, even after ultraviolet irradiation, an optical element-forming material layer did not become a film.

### Comparative Example 3

The conditions of Comparative Example 6 were same as those of Example 4 except that benzyl methacrylate (SP value: 10.8), which is monoacrylate, was used as a monomer, and xylene (SP value: 8.8) was used as a low-molecular substance. However, even after ultraviolet irradiation, an optical element-forming material layer did not become a film.

### Comparative Example 7

The optical element of Comparative Example 7 was produced under the same conditions as Example 1 except that, as shown in FIG. 4, a diffusion plate 3 (“LSD 40” (trade name), Luminit LLC, thickness: 135 μm) having a half-width of 40° was placed on the PET film 2 at the side irradiated with ultraviolet. When the scattering property of the optical element with the PET films was measured, the optical element had a property shown in FIG. 2 and did not show directional scattering.

### Comparative Example 8

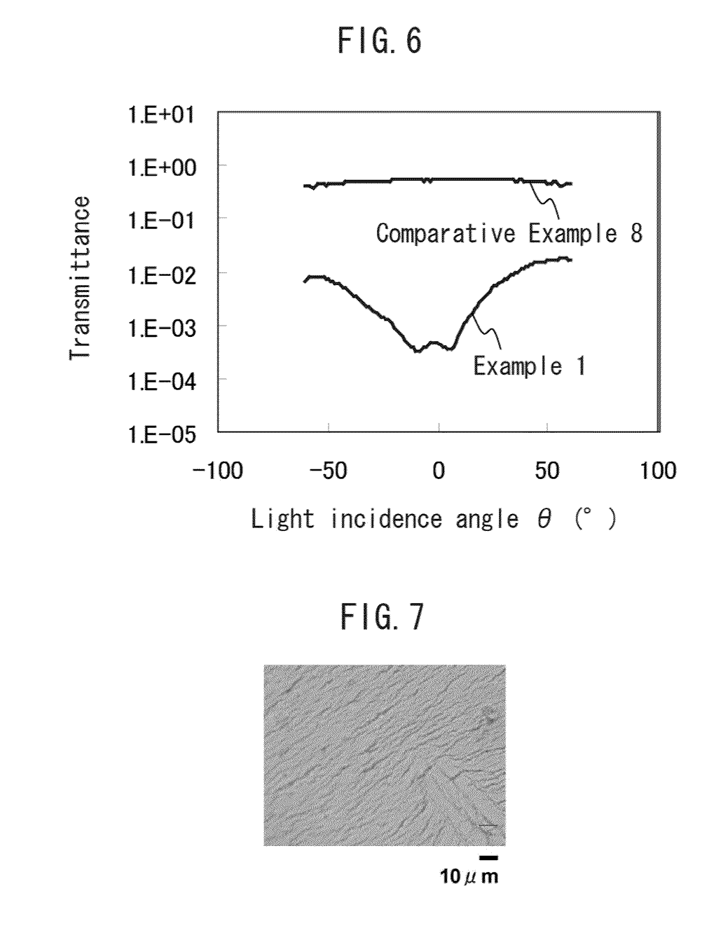

The optical element of Comparative Example 8 was produced under the same conditions as Example 2 except that ethyl acetate (SP value: 9.1) was used as a low-molecular substance. Although the optical element-forming material layer became a film (the optical element-forming material layer became clouded and was cured), when the scattering property of the optical element with the PET films was measured, the optical element had a property shown in FIG. 6 and did not show directional scattering. Further, when the surface and the cross section of the optical element obtained were observed, as shown in the photograph in FIG. 7, there were no oval structures, which could be seen in the optical element of Example 1. Further, through holes were not observed in the thickness direction of the optical element obtained.

### Comparative Example 9

The optical element of Comparative Example 9 was produced under the same condition as Example 2 except that toluene (SP value: 8.9 was used as a low-molecular substance. Although the optical element-forming material layer became a film (the optical element-forming material layer became clouded and was cured), when the scattering property of the optical element with the PET films was measured, directional scattering was not observed as in the case of Comparative Example 8.

The compositions of the optical element-forming materials of Examples and Comparative Examples, and evaluation results of various properties and physical properties are summarized in Table 1.

TABLE 1

| | | | | SP value | | | Half-width | | | | |
|---|---|---|---|---|---|---|---|---|---|---|---|
| | | | Low- | | Low- | | of | | | | |
| | Monomer | | molecular | | molecular | | diffusion | | Through | Directional | Thickness |
| | Type | Content | substance | Monomer | substance | Difference | plate | Filming | hole | scattering | (μm) |
| Ex. 1 | LC242 | 50 wt % | CPN | 12.3 | 10.4 | 1.9 | — | Yes | Yes | Yes | 100 |
| Ex. 2 | LC242 | 20 wt % | CPN | 12.3 | 10.4 | 1.9 | — | Yes | Yes | Yes | 100 |
| Ex. 3 | LC242 | 50 wt % | Methylene | 12.3 | 9.7 | 2.6 | — | Yes | Yes | Yes | 100 |
| | | | chloride | | | | | | | | |
| Ex. 4 | LC242 | 20 wt % | Methylene | 12.3 | 9.7 | 2.6 | — | Yes | Yes | Yes | 100 |
| | | | chloride | | | | | | | | |
| Ex. 5 | LC242 | 50 wt % | CPN | 12.3 | 10.4 | 1.9 | 20° | Yes | Yes | Yes | 100 |
| Ex. 6 | LC242 | 50 wt % | CPN | 12.3 | 10.4 | 1.9 | — | Yes | Yes | Yes | 100 |
| | | | (removed) | | | | | | | | |
| Comp. | BzM | 50 wt % | CPN | 10.8 | 10.4 | 0.4 | — | No | No | No | — |
| Ex. 1 | | | | | | | | | | | |
| Comp. | BzM | 20 wt % | CPN | 10.8 | 10.4 | 0.4 | — | No | No | No | — |
| Ex. 2 | | | | | | | | | | | |
| Comp. | BzM | 50 wt % | Methylene | 10.8 | 9.7 | 1.1 | — | No | No | No | — |
| Ex. 3 | | | chloride | | | | | | | | |
| Comp. | BzM | 20 wt % | Methylene | 10.8 | 9.7 | 1.1 | — | No | No | No | — |
| Ex. 4 | | | chloride | | | | | | | | |
| Comp. | BzM | 50 wt % | Xylene | 10.8 | 8.8 | 2.0 | — | No | No | No | — |
| Ex. 5 | | | | | | | | | | | |
| Comp. | BzM | 20 wt % | Xylene | 10.8 | 8.8 | 2.0 | — | No | No | No | — |
| Ex. 6 | | | | | | | | | | | |
| Comp. | LC242 | 50 wt % | CPN | 12.3 | 10.4 | 1.9 | 40° | Yes | No | No | 100 |
| Ex. 7 | | | | | | | | | | | |
| Comp. | LC242 | 20 wt % | Ethyl acetate | 12.3 | 9.1 | 3.2 | — | Yes | No | No | 100 |
| Ex. 8 | | | | | | | | | | | |
| Comp. | LC242 | 20 wt % | Toluene | 12.3 | 8.9 | 3.4 | — | Yes | No | No | 100 |
| Ex. 9 | | | | | | | | | | | |

*BzM: benzyl methacrylate
*CPN: cyclopentanone

As summarized in Table 1, the optical elements of Examples 1 to 6 had through holes and showed directional scattering. In contrast, with respect to Comparative Examples 1 to 6, even after ultraviolet irradiation, the optical element-forming material layers did not become films. With respect to Comparative Example 7, the optical element did not show directional scattering. With respect to Comparative Examples 8 and 9, although the optical element-forming material layers became films, through holes were not observed and the optical element did not show directional scattering.

### INDUSTRIAL APPLICABILITY

The optical element of the present invention is used suitably for a liquid crystal display. Examples of the applications thereof include office automation equipment such as a PC monitor, a notebook PC, and a copy machine, portable devices such as a mobile phone, a watch, a digital camera, a personal digital assistant (PDA), and a handheld game machine, home electric appliances such as a video camera, a television set, and a microwave oven, vehicle equipment such as a back monitor, a monitor for a car-navigation system, and a car audio device, display equipment such as an information monitor for stores, security equipment such as a surveillance monitor, and nursing and medical equipment such as a monitor for nursing care and a monitor for medical use.

What is claimed is:

1. An optical element comprising:
a plurality of through holes in a transparent film matrix, wherein the plurality of through holes are placed in a state where axial directions thereof are approximately in parallel with one another, and the axial directions of the through holes are inclined or approximately parallel to a thickness direction of the transparent film matrix.

2. The optical element according to claim 1, wherein a diameter of the through hole is in a range from 0.5 to 10 μm.

3. The optical element according to claim 1, wherein a thickness is in a range from 10 to 470 μm.

4. A directional diffusion film comprising:
an optical element, wherein the optical element is the optical element according to claim 1.

5. A method of manufacturing an optical element comprising a plurality of through holes in a transparent film matrix, wherein the plurality of through holes are placed in a state where axial directions thereof are approximately in parallel with one another, the axial directions of the through holes are inclined or approximately parallel to a thickness direction of the transparent film matrix, and the through holes are filled with a low-molecular substance, and wherein
the method comprises processes of:
providing an optical element-forming material containing a monomer having a photopolymerizable functional group and the low-molecular substance, the difference between the SP values thereof being in a range from 1.5 to 3;
forming an optical element-forming material layer by coating a first substrate with the optical element-forming material; and
irradiating the optical element-forming material layer with a parallel beam.

6. The method of manufacturing an optical element according to claim 5, wherein the monomer has an SP value in a range from 11.7 to 13.4.

7. The method of manufacturing an optical element according to claim 5, wherein the low-molecular substance has an SP value in a range from 9.7 to 10.4.

8. The method of manufacturing an optical element according to claim 5, wherein the monomer is at least a liquid crystalline monomer.

9. The method of manufacturing an optical element according to claim 5, wherein the monomer has at least two polymerizable functional groups, and the polymerizable functional groups are acrylate groups.

10. The method of manufacturing an optical element according to claim 5, wherein the low-molecular substance is a solvent.

11. The method of manufacturing an optical element according to claim 5, wherein on the optical element-forming material layer on the first substrate in the process of forming the optical element-forming material layer, a second substrate is further placed, the optical element-forming material layer is interposed, between the both substrates, and the optical element-forming material layer is irradiated with the parallel beam in this state.

12. The method of manufacturing an optical element according to claim 5, further comprising a process of:
removing the low-molecular substance after the process of parallel beam irradiation.

13. The method of manufacturing an optical element according to claim 12, wherein after the process of removing the low-molecular substance, portions winch are obtained by removing low-molecular substance are filled with a substance having a refractive index different from that of a polymer made in the process of parallel beam irradiation by polymerization.

14. An optical element manufactured by the method of manufacturing an optical element according to claim 5.
